(19) United States
(12) Patent Application Publication
(10) Pub. No.: US 2011/0199604 A1
(43) Pub. Date: Aug. 18, 2011

(54) OPTICAL FIBER HYDROGEN DETECTION SYSTEM AND METHOD

(76) Inventor: Rogerio Ramos, Eastleigh (GB)

(21) Appl. No.: 12/743,590

(22) PCT Filed: Nov. 21, 2008
(86) PCT No.: PCT/US08/84361

§ 371 Date: Aug. 2, 2010

Related U.S. Application Data
(60) Provisional application No. 60/989,688, filed on Nov. 21, 2007.

(51) Int. Cl. G01J 3/00; G01N 21/00

(52) U.S. Cl. 356/51; 356/73.1

(57) ABSTRACT

A sensing system and method to detect or measure presence of hydrogen, including exposing a sensing fiber consisting essentially of an optical fiber to an environment; and detecting a characteristic of the sensing fiber at or in a structure and at one or more wavelengths where the characteristic changes with the presence of hydrogen.

### CROSS REFERENCE TO RELATED CASES

The present invention is related to and claims the benefit or priority from U.S. Provisional Patent Application Ser. No. 60/989,688 of RAMOS, entitled “OPTICAL FIBER HYDROGEN DETECTION SYSTEM,” filed on Nov. 21, 2007, the entire contents of which are hereby incorporated by reference herein.

### FIELD OF THE INVENTION

The invention generally relates to hydrogen detection, and more particularly to a system and method for hydrogen detection using an optical fiber.

### BACKGROUND

It is known that hydrogen is generated in several industrial processes. It is also known that hydrogen is an explosive gas, and accordingly, limits on the concentration of hydrogen are imposed by law and sound industrial practices to assure occupational safety. Thus, monitoring of the presence of hydrogen and hydrogen concentrations is necessary in a number of industries and environments.

In the past, proposals have been made for monitoring the presence and sometimes content of hydrogen in surrounding gases. For example, Buchanan et al., U.S. Pat. No. 5,153,931, discusses an apparatus and method for detecting a chemical substance, such as hydrogen, by exposing an optic fiber having a core and a cladding, particularly silica cladding, to allow adsorption of hydrogen onto the surface of the cladding. The adsorption changes the transmissivity of the optic fiber. Light from a light source is received by a first end of the fiber through a first end of a container surrounding the fiber and is carried by the core of the optic fiber through the inside of the container. The change in the transmissivity of the fiber is measured by a spectrophotometer at the other end of the fiber through a second end of the container. Hydrogen is detected by the absorption of infrared light carried by the optic fiber with the silica cladding. Light in the near infrared spectrum passed along the optic fiber will have increased absorption at the wavelengths between about 1.6 to 2.42 microns due to the adsorption of hydrogen onto the surface of the cladding. However, use of such wavelengths is not convenient for operation, due to attenuation of the fiber itself, and due to the high cost of light sources and detectors in such a range. In addition, in the system of Buchanan et al., the measurements were restricted to being conducted inside of a container, including the sensing optic fiber, and in which the gas to be tested had to be inserted.

Benson et al., U.S. Pat. No. 7,306,951, discusses a method and apparatus for determining diffusible hydrogen concentrations, particularly for use in welding applications. The apparatus includes a sensor assembly that, with an included sealing member, defines a sample area on a weld bead from which hydrogen evolves into a sample volume, defined by a sensor housing and a sensor of the sensor assembly. The hydrogen reacts with a sensing layer and a reflector layer positioned on the end of an optical fiber, all being included in the sensor assembly and positioned within the sensor. The sensing layer includes a chemochromic material which undergoes changes in physical properties, such as optical transmission properties, when it reacts with hydrogen and these changes are measured by the measuring apparatus to determine the amount of hydrogen evolving from the sample area. Additionally, a different optical fiber is joined to the sensor optical fiber to direct light transmitted by a light source in a hydrogen monitoring assembly through the sensing layer to strike the reflector layer which reflects light back through the second optical fiber to a detector in the hydrogen monitoring assembly. A signal analyzer is included in the hydrogen monitoring assembly and is calibrated and configured to measure the diffusible hydrogen concentration in the weld bead, based on the measured changes in the optical transmission properties of the sensing layer. However, the use of the sensing layer, limits the system of Benson et al. to operation only at the fiber end. In addition, contamination and deterioration of the sensing layer is also an issue.

Nonetheless, there is a need for a system and method for detection of hydrogen and measurements of hydrogen concentration or hydrogen leaks in process, storage or distribution systems, and for detection of corrosion that generates hydrogen, and where the detection is made in-situ, without the need of moving gases into a separate container and without the use of sensing layers. One area of technology where such needs exist is deep sea well technology.

### SUMMARY OF THE INVENTION

The above and other needs and problems are addressed by the exemplary embodiments of the present invention, which provide a system and method that use an optical fiber to provide in-situ measurements of hydrogen concentration or hydrogen leaks in process, storage or distribution systems. Such measurements also can be advantageously used to detect corrosion that generates hydrogen. An exemplary radiation sensing system and method are also disclosed.

Accordingly, in exemplary aspects of the present invention there is provided a sensing system and method to detect or measure the presence of hydrogen, including exposing a sensing fiber consisting essentially of an optical fiber to an environment; and detecting a characteristic of the sensing fiber at or in a structure and at one or more wavelengths where the characteristic changes with the presence of hydrogen.

Still other aspects, features, and advantages of the present invention are readily apparent from the entire description thereof, including the figures, which illustrates a number of exemplary embodiments and implementations. The invention is also capable of other and different embodiments, and its several details can be modified in various respects, all without departing from the spirit and scope of the invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary attenuation spectrum of an optical fiber in near infrared and loss curves of main attenuation features;

FIG. 2 illustrates an exemplary system employing an optical spectrum analyzer (OSA) to detect attenuation of an optical fiber as a function of wavelength to increase selectivity;

FIG. 3 illustrates an exemplary system employing optical time domain reflectometry (OTDR) to interrogate an optical fiber and to provide information of a location of detection along its length; and

FIGS. 4A-4B illustrate exemplary systems employing optical time domain reflectometry (OTDR) to interrogate an optical fiber and to provide information of multiple locations of detection along its length.

### DETAILED DESCRIPTION

Various embodiments and aspects of the invention will now be described in detail with reference to the accompanying figures. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited. Further, whenever a composition, a group of elements or any other expression is preceded by the transitional phrase “comprising”, “including” or “containing”, it is understood that we also contemplate the same composition, the group of elements or any other expression with transitional phrases “consisting essentially of”, “consisting”, or “selected from the group of consisting of”, preceding the recitation of the composition, the elements or any other expression.

Generally, the effect of hydrogen on optical attenuation of optical fibers is the subject of the exemplary embodiments that can include both an analytical and an experimental approach. The exemplary systems and methods employ a relationship between hydrogen partial pressure and optical attenuation at different wavelengths, and can include methods and procedures of calibration of the measurements. The hydrogen detected and/or measured may be hydrogen which leaks into or from a structure.

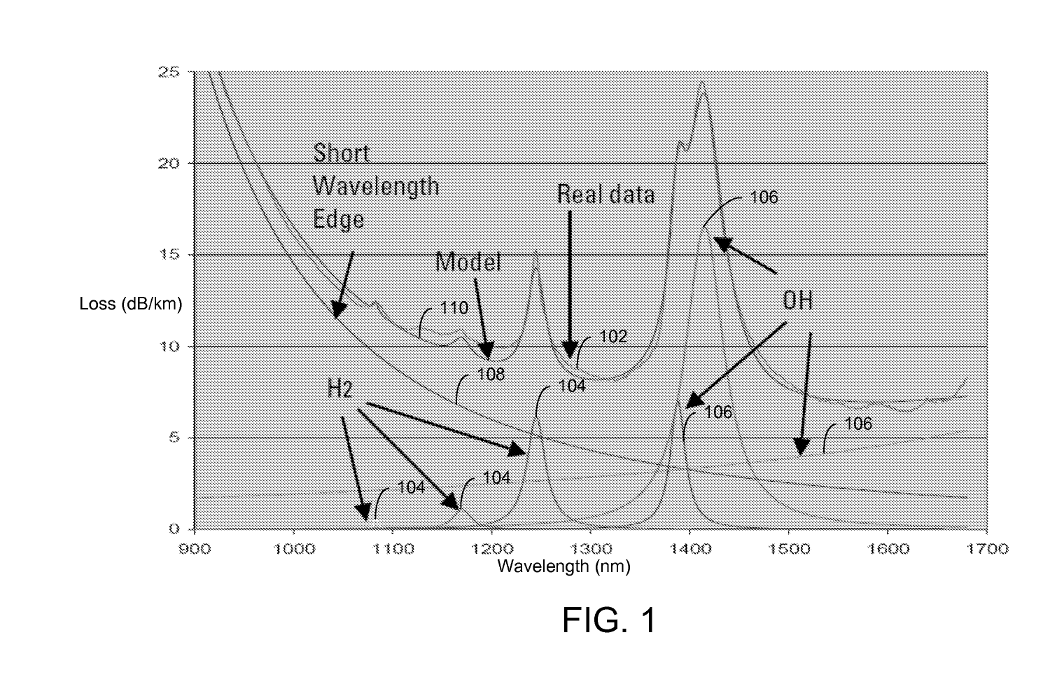

Referring now to the drawings, wherein like reference numerals designate identical or corresponding parts throughout the several views, and more particularly to FIG. 1 thereof, there is illustrated an exemplary attenuation spectrum of an optical fiber in near infrared and loss curves of main attenuation features. In FIG. 1, the attenuation spectrum of an optical fiber exposed to hydrogen can be decomposed in a series of curves or peaks that represent the attenuation due to different known effects. Without wishing to be bound by any operability theory, it is believed that the main effects are attenuation caused by hydrogen ingression into the glass fiber, the attenuation due to OH ions formed by the reaction between the hydrogen and the glass, and the short wavelength edge related to defects on the glass and temperature. Again, without being limited to any operability theory, the rate of increase of attenuation depends above all on the concentration of hydrogen, the temperature, and the glass composition.

The exemplary embodiments employ the measured attenuation spectra of optical fibers and provide a measure of attenuation generated by such hydrogen effects. Accordingly, FIG. 1 shows the attenuation spectrum data 102 of an optical fiber in the near infrared (real data) with hydrogen effects. The real data 102 is decomposed into a series of loss curves of the main attenuation features observed, for example, including H₂ curves 104, OH curves 106, and the short wavelength edge curve 108. A model curve 110 is composed of the sum of the individual contributions and can include one or more wavelength values or peaks of at least one of about 1080 nm, about 1180 nm or about 1240 nm for H₂, and at least one of about 1390 nm or about 1400 nm for OH, as shown in FIG. 1.

In an exemplary embodiment, hydrogen detection and hydrogen concentration measurements can be achieved by monitoring the different contributions of the different effects and by applying a suitable algorithm based on the knowledge of the behavior of the fiber under known hydrogen concentrations. This information then is employed for creation of a model (e.g., based on the model curve 110) of the fiber attenuation as a function of presence and concentration of hydrogen and to calibrate specific fibers to be used as hydrogen sensors. The hydrogen concentration can be determined by passing the light of the same wavelength as was used to create the model through the fiber and measuring the attenuation with a suitable instrument, such as spectrophotometer. The measured attenuation is then correlated to the hydrogen concentration from the model.

In an exemplary embodiment, the attenuation spectrum of the optical fiber used as sensing element is interpreted in order to provide the correct hydrogen concentration. This is done by analyzing the attenuation increase and/or the rate of increase of each component of the attenuation spectrum. The components are obtained by separating the spectrum curve into a series of elements, including spectral shapes, such as Lorenzian or Gaussian curves centered at wavelengths related to different effects, processes or chemical reactions in the fiber, and the like. Once the behavior of such elements is known for the fiber used as sensing element, corresponding parameters can be included in a model or algorithm that calculates the hydrogen concentration. Depending on the number of other variables, the measurement can then be simplified to one or more key wavelengths, in order to provide a hydrogen concentration measurement.

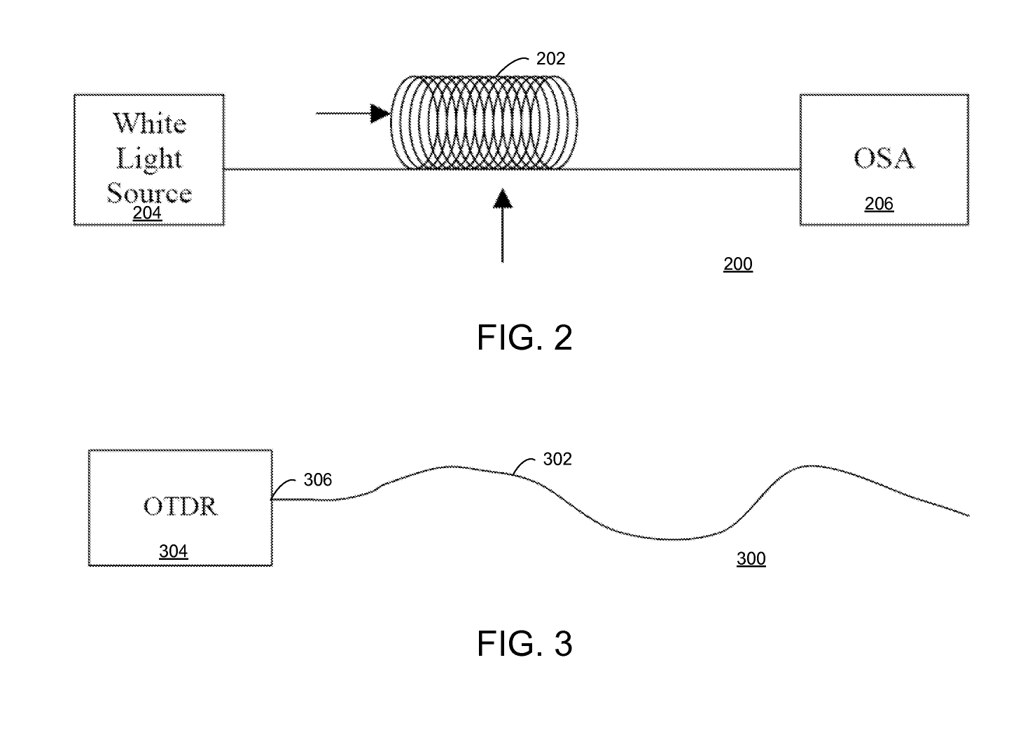

The exemplary embodiments also can be used to measure small partial pressures of hydrogen which might be difficult to detect using other methods. FIG. 2 illustrates an exemplary system 200 employing an optical spectrum analyzer (OSA) or spectrometer 206 configured to detect attenuation, i.e., loss of signal power (e.g., in dB/km) of an optical fiber 202 driven by a white light source 204 as a function of wavelength (e.g., in nm) to increase selectivity. Generally, the OSA 206 is an optical instrument used to measure properties of light over a specific portion of the electromagnetic spectrum, typically used in spectroscopic analysis to identify materials. The variable measured is most often the light's intensity but could also, be for instance, the polarization state. The independent variable is usually the wavelength of the light, normally expressed as some fraction of a meter, but sometimes expressed as some unit directly proportional to the photon energy, such as wavenumber or electron volts, which has a reciprocal relationship to wavelength. The OSA 206 can be used in spectroscopy for producing spectral lines and measuring their wavelengths and intensities. Spectrometer is a term that is applied to instruments that operate over a very wide range of wavelengths, from gamma rays and X-rays into the far infrared. Alternatively, a spectrophotometer may be used as the OSA. The spectrophotometer measures the intensity of radiation as a function of frequency (or wavelength) of the radiation, such as ultraviolet or infrared light.

FIG. 3 illustrates an exemplary system 300 employing as instrument based on optical time domain reflectometry (OTDR) 304, such as an optical type domain reflectometer, to interrogate an optical fiber 302 and to provide information of a location of detection along its length. Generally, the OTDR 304 is an optoelectronic instrument used to characterize an optical fiber. The OTDR 304 injects a series of optical pulses into an end 306 of the fiber 302 and also extracts from the same end 306 of the fiber 302 light that is scattered back and reflected back from points in the fiber 302 where the index of refraction changes (e.g., this is equivalent to the way that an electronic time-domain reflectometer (TDR) measures reflections caused by changes in the impedance of the cable under test). The intensity of the return pulses is measured and integrated as a function of time, and is plotted as a function of the length of the fiber 302. The OTDR 304 also can be used for estimating the length of the fiber 302 and overall attenuation of the fiber 302, including splice and mated-connector losses. The OTDR 304 also can be used to locate faults in the fiber 302, such as breaks in the fiber 302. The use of such exemplary OTDR techniques can be used not only to measure hydrogen concentration, but also in locating such concentration along the fiber. Advantageously, this can be used for monitoring hydrogen at long structures, such as pipes or cables or transport lines (roads, railways, etc).

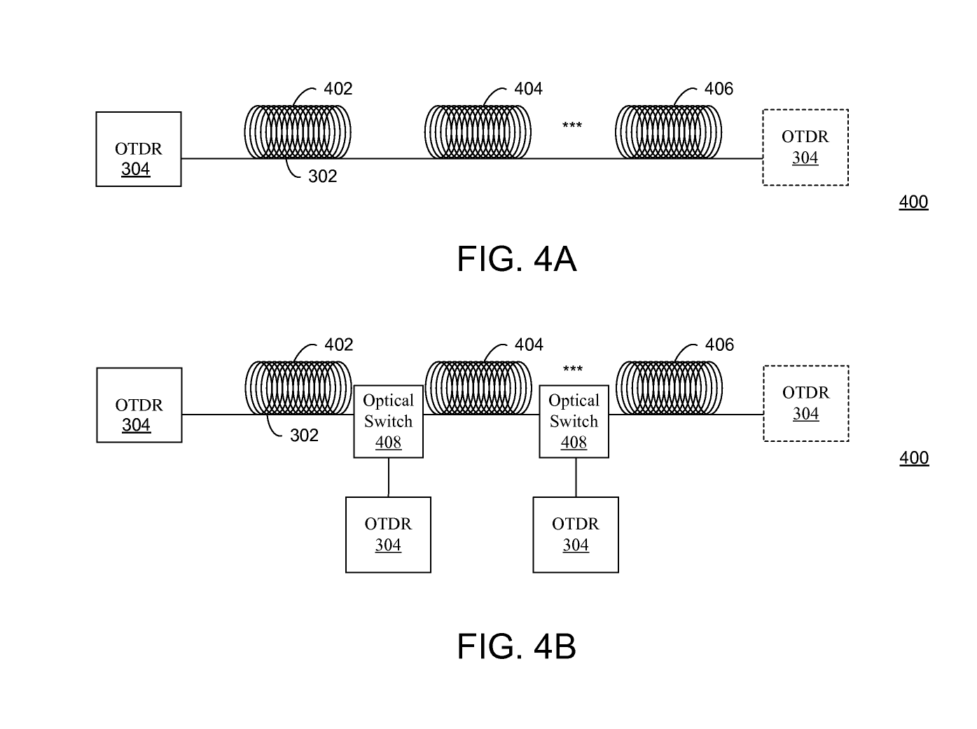

Accordingly, in an exemplary embodiment, the detection of hydrogen can be done using an integrated loss along the whole of the sensing fiber 202, as illustrated in FIG. 2, or as a distributed measurement along the fiber 302, as illustrated in FIG. 3. In general, the use of the integrated loss along the whole fiber 202 can be used to achieve high sensitivity. The use of spectral analysis via the OSA or spectrometer 206 allows increasing selectivity, if other effects are believed to also cause attenuation at the wavelength of interrogation. The distributed measurements can be achieved by the use of the OTDR 304 or other methods, such as with an optical frequency domain reflectometry. If even better sensitivity at given points along a structure or along different parts of the structure is advantageous, in a further exemplary embodiment, as shown in FIG. 4A, an exemplary system 400 includes the fiber 302 configured as an array of one or more fibers or fiber coils 402-406 provided at given points along a structure or along different parts of the structure, and daisy-chained or connected in series with each other, and with the above-noted OTDR 304 or other suitable systems employed to interrogate the fibers or fiber coils 402-406 at one end or both ends thereof and make individual respective measurements based on the characteristics of the sensing fibers or fiber coils 402-406 changing due to the presence of hydrogen at the locations thereof.

In a further exemplary embodiment, as shown in FIG. 4B, the exemplary system 400 of FIG. 4A includes the fibers or fiber coils 402-406 connected through respective optical fiber switches 408 (e.g., any known optical fiber switches) to respective OTDRs 304 or other suitable systems employed to interrogate the fibers or fiber coils 402-406. Advantageously, the respective optical fiber switches 408 can be used to connect the respective fibers or fiber coils 402-406 to the respective OTDRs 304, as needed, at different times, and the like.

Accordingly, the sensing fibers can be made for various applications and arranged in many different shapes and configurations, such as made into one or more coil shapes, as shown in FIGS. 2 and 4, as an extended fiber, as shown in FIG. 3, or as any suitable combination thereof, and, as will be appreciated by those skilled in the relevant arts. For example, when the fiber, such as fiber 202 is used as a coil, the coil can be placed in reactor chambers, tanks, pipelines, or in any suitable environment where the hydrogen detection is desired or can be used to interrogate flow of substances in a pipeline, for example, to detect leaks of hydrogen in a pipe or a vessel. The fiber, such as fibers 202 or 302, can be extended to cover longer lengths of pipe, cable, process plant, or any other environment where a long length needs to be interrogated. The fiber can be installed permanently or temporarily. The fiber can be deployed as part of a structure, tube or cable, and it could be pumped into a tube. The fiber can also be placed in between tubes when a “tube in tube” configuration is used or in the skin or cladding of vessels or pipes.

Any suitable types of fibers can be selected for use as a hydrogen detecting fiber, such as multi-mode 50/125 graded index fibers. In one embodiment, an optimized fiber composition can be employed. For example, in an exemplary embodiment, the phosphorus (or other elements) doping in the fiber core can be used to increase the fiber sensitivity to hydrogen in certain wavelengths. Thus, the doping elements can include germanium, phosphorus, fluorine, aluminum, nitrogen, and the like. In one embodiment, the optical fiber can include a silica glass fiber, encased by an outer cladding, which can be made from any suitable material, such as acrylate or polyimide or silicon, and the like.

In further exemplary embodiments, a special fiber can be employed as the sensing fiber, wherein in some applications it will be beneficial to use a suitable fiber that is not very reactive with hydrogen, for example, to improve the reversibility of the measurement. In other applications, it will be beneficial to use a suitable fiber that is highly reactive to hydrogen, for example, to detect cumulative effect of hydrogen or to enhance the sensitivity of the system.

The exemplary embodiments can also be applied to radiation detection, such as gamma rays wherein suitable fibers have attenuation signatures for radiation that can be detected using the exemplary embodiments. For example, the sensitivity of an optical fiber to radiation can be increased when the fiber is in the presence of or is contacted by hydrogen. Accordingly, an exemplary system to increase the sensitivity to radiation includes exposing the sensing fiber to hydrogen, wherein hydrogen can be added to a vessel or tube including the optical fiber and with the advantage of increasing the sensitivity of the fiber to radiation. The exposure to hydrogen can be conducted in any desirable manner, so long as it results in the desired, increased sensitivity to radiation.

Thus, the exemplary sensing system can be used to detect or measure the presence of hydrogen and can include an optical fiber and means for detecting a characteristic of the optical fiber at one or more wavelengths where the characteristic changes with the presence of hydrogen. The exemplary method for detecting or measuring the presence of hydrogen can include exposing an optical fiber to the environment, and detecting a characteristic of the optical fiber at one or more wavelengths where the characteristic changes with the presence of hydrogen. The detected presence of hydrogen can be related to a chemical process or to corrosion. For example, corrosion of a structure can be evaluated using the exemplary hydrogen detection or measurement system. The determined characteristic of the fiber can include attenuation, attenuation rate change, index of refraction and/or index of refraction rate change. The wavelengths of interest can include values of about 1080 nm, about 1180 nm, about 1240 nm, about 1390 nm, about 1400 nm or a combination thereof. An optical time or frequency domain technique can be employed to locate a section of the optical fiber exposed to hydrogen. The utilization of such optical time or frequency domain techniques for this purpose can be implemented by recording the backscattering signal as a function of time, based on an optical pulse transmitted into the fiber. The fiber can be placed in the vicinity of or in contact with or imbedded into a pipe, or tube, or production tubing, or casing, or riser, or flow line, or umbilical used in deep sea well technology or can be placed near a sub-sea structure, such as a tree sub-sea structure, or a manifold, or a processing system, or can be placed inside a tubular structure, or between tubes of a tubular structure, such as a tube bundle or a pipe in pipe. Advantageously, such structures can be located under water or under ground.

Advantageously, the exemplary hydrogen detection system and method can be used to perform hydrogen detection in-situ, without the need of moving gases into a separate container, and without the use of sensing layers in addition to the optical sensing fiber, as compared to conventional systems and methods.

Applications for the exemplary hydrogen detection system and method can include hydrogen detection in processes that generate hydrogen, such as corrosion monitoring, and similar environments. Further applications can include detection of hydrogen emissions due to temperature or other factors, control of chemical processes involving hydrogen, and leak detection of hydrogen in storage devices, pipelines, fuel cells, fuel tanks, and similar environments. The exemplary embodiments can include applications in a number of industries, such as automotive, aerospace, process plants, and similar environments. In addition, hydrogen can be a safety hazard, as it can cause an explosion. Accordingly, hydrogen detection is very valuable to all suitable applications where hydrogen is employed or generated.

While the inventions have been described in connection with a number of exemplary embodiments, and implementations, the inventions are not so limited, but rather cover various modifications, and equivalent arrangements, which fall within the purview of the present claims.

What is claimed is:

1. A sensing system to detect or measure a presence of hydrogen at or in a structure, the system comprising:
a sensing fiber consisting essentially of an optical fiber; and
means for detecting a characteristic of the sensing fiber at or in a structure and at one or more wavelengths where the characteristic changes with the presence of hydrogen.

2. The system of claim 1, wherein the detected presence of hydrogen is related to a chemical process.

3. The system of claim 1, wherein the detected presence of hydrogen is related to corrosion.

4. The system of claim 1, wherein corrosion of the structure is evaluated using the sensing system.

5. The system of claim 1, wherein the characteristic of the fiber is attenuation and/or index of refraction.

6. The system of claim 1, wherein the one or more wavelengths include a value of about 1080 nm, about 1180 nm, about 1240 nm, about 1390 nm, about 1400 nm or a combination thereof.

7. The system of claim 1, wherein an optical time or frequency domain technique is used to locate a section of the sensing fiber exposed to hydrogen.

8. The system of claim 1, wherein the structure is either under a surface of water or under a surface of earth.

9. The system of claim 1, wherein the structure is a pipe, a tube, a production tubing, a casing, a riser, a flow line, a jumper, an offloading line, an umbilical, a well, a well head, a manifold, a platform, a vessel, or a processing system.

10. The system of claim 1, wherein the sensing fiber is placed inside a tubular structure.

11. The system of claim 1, wherein the sensing fiber is placed between tubes of a tubular structure, including a tube bundle or a pipe in pipe.

12. The system of claim 1, wherein a parameter of attenuation and/or attenuation rate change of the sensing fiber at the one or more wavelengths is used to measure hydrogen concentration.

13. The system of claim 1, wherein tests are performed to calibrate the hydrogen measurement.

14. The system of claim 1, wherein dissociation of an attenuation spectrum of the sensing fiber is used to calculate the hydrogen concentration or to calibrate the hydrogen measurement.

15. The system of claim 1, wherein a parameter of index of refraction and/or index of refraction rate change of the sensing fiber at the one or more wavelengths is used to measure hydrogen concentration.

16. The system of claim 1, wherein a special fiber is used as the sensing fiber.

17. The system of claim 16, wherein the special fiber is selected to present low reactivity with hydrogen.

18. The system of claim 16, wherein the special fiber is selected to present high reactivity with hydrogen.

19. The system of claim 1, wherein the system is configured to evaluate hydrogen leaking from or to the structure.

20. The system of claim 1, wherein the system is configured to locate hydrogen leaking from or to the structure.

21. The system of claim 1, wherein the system is configured to detect radiation.

22. The system of claim 1, wherein the system includes sections of the sensing fibers connected in series to detect different parts of the structure.

23. The system of claim 1, wherein the system has sections of the sensing fibers connected through a switch to detect different parts of the structure.

24. A method of detecting or measuring the presence of hydrogen at or in a structure, the method comprising:
exposing a sensing fiber consisting essentially of an optical fiber to an environment; and
detecting a characteristic of the sensing fiber at or in a structure and at one or more wavelengths where the characteristic changes with the presence of hydrogen.

25. The method of claim 24, wherein the detected presence of hydrogen is related to a chemical process.

26. The method of claim 24, wherein the detected presence of hydrogen is related to corrosion.

27. The method of claim 24, wherein corrosion of the structure is evaluated using the method of detecting or measuring the presence of hydrogen.

28. The method of claim 24, wherein the characteristic of the fiber is attenuation and/or index of refraction.

29. The method of claim 24, wherein the one or more wavelengths include a value of about 1080 nm, about 1180 nm, about 1240 nm, about 1390 nm, about 1400 nm or a combination thereof.

30. The method of claim 24, wherein an optical time or frequency domain technique is used to locate a section of the sensing fiber exposed to hydrogen.

31. The method of claim 24, wherein the structure is either under a surface of water or under a surface of earth.

32. The method of claim 24, wherein the structure is a pipe, a tube, a production tubing, a casing, a riser, a flow line, a jumper, an offloading line, an umbilical, a well, a well head, a manifold, a platform, a vessel, or a processing system.

33. The method of claim 24, wherein the sensing fiber is placed inside a tubular structure.

34. The method of claim 24, wherein the sensing fiber is placed between tubes of a tubular structure, including a tube bundle or a pipe in pipe.

35. The method of claim 24, wherein a parameter of attenuation and/or attenuation rate change of the sensing fiber at the one or more wavelengths is used to measure hydrogen concentration.

36. The method of claim 35, wherein tests are performed to calibrate the hydrogen measurement.

37. The method of claim 35, wherein dissociation of an attenuation spectrum of the sensing fiber is used to calculate the hydrogen concentration or to calibrate the hydrogen measurement.

38. The method of claim 24, wherein a parameter of index of refraction and/or index of refraction rate change of the sensing fiber at the one or more wavelengths is used to measure hydrogen concentration.

39. The method of claim 24, wherein a special fiber is used as the sensing fiber.

40. The method of claim 39, wherein the special fiber is selected to present low reactivity with hydrogen.

41. The method of claim 39, wherein the special fiber is selected to present high reactivity with hydrogen.

42. The method of claim 24, further comprising evaluating hydrogen leaking from or to the structure.

43. The method of claim 24, further comprising locating hydrogen leaking from or to the structure.

44. The method of claim 24, further comprising detecting radiation.

45. The method of claim 24, further comprising providing sections of the sensing fibers connected in series to detect different parts of the structure.

46. The method of claim 24, further comprising providing sections of the sensing fibers connected through a switch to detect different parts of the structure.
